(19) United States
(12) Patent Application Publication
(10) Pub. No.: US 2012/0177484 A1
(43) Pub. Date: Jul. 12, 2012

(54) Elliptical Sealing System

(75) Inventors: Roderick Mark Lusted, Niskayuna, NY (US); Farshad Ghasripoor, Scotia, NY (US); Bruce William Brisson, Galway, NY (US); Franco Sarri, Frienze (IT)

(73) Assignee: GENERAL ELECTRIC COMPANY, Schnectady, NY (US)

(21) Appl. No.: 12/986,226

(22) Filed: Jan. 7, 2011

(51) Int. Cl. F04D 29/08; F16J 15/16

(52) U.S. Cl. 415/173.4; 277/500

(57) ABSTRACT

The present application provides an elliptical sealing system for use with a rotor and a stator housing of a rotary machine. The elliptical sealing system may include a number of sealing segments with an abradable coating thereon. The sealing segments with the abradable coating thereon may have a substantially elliptical shape. A number of biasing members may be in communication with the sealing segments and the stator housing.

### TECHNICAL FIELD

The present application relates generally to seals for use with rotary machines and more particularly relates to a compliant and an abradable labyrinth sealing system having an elliptical shape for use with a rotary machine such as a rotary compressor and the like.

### BACKGROUND OF THE INVENTION

In a rotary machine, one or more seal generally extend along an interface between the rotating and the stationary components. For example, compressors, turbines, and the like may have one or more seals at the interface between a series of rotating blades or buckets disposed within a casing or a vane. These seals are intended to preserve a pressure differential across the rotating components between upstream and downstream sides thereof. A smaller clearance dimension at the seal generally increases the performance of the seal and the efficiency of the overall rotary machine by limiting the leakage thereacross.

The seals and the components thereof, however, may be subject to relatively high temperatures, thermal gradients, and thermal expansion and contraction during various operational stages of the rotary machine such as during start-up and during other types of transient operations. Typically, the seal includes an extra clearance dimension to reduce the likelihood of contact and damage between the rotating and the stationary components during such transient operations. This extra clearance dimension, however, also may reduce the performance and efficiency of the seal and the overall rotary machine because of the leakage flow across the seal. Fluid leakage between the rotor and the casing may lower the efficiency of the compressor and hence lead to increased fuel costs.

There is thus a desire for an improved sealing system for a rotary machine such as a compressor and the like that reduces leakage therethrough while maintaining adequate clearance during transient operations as well as during steady state operating conditions. Such reduced leakage should improved overall efficiency while preventing damage to the components herein.

### SUMMARY OF THE INVENTION

The present application thus provides an elliptical sealing system for use with a rotor and a stator housing of a rotary machine. The elliptical sealing system may include a number of sealing segments with an abradable coating thereon. The sealing segments with the abradable coating thereon may have a substantially elliptical shape. A number of biasing members may be in communication with the sealing segments and the stator housing.

The present application further provides an elliptical sealing system for use with a rotor and a stator housing of a rotary machine. The elliptical sealing system may include a pair of elliptical sealing segments with an abradable coating thereon. A number of biasing members may be in communication with the elliptical sealing segments and the stator housing so as to bias the pair of elliptical sealing segments with the abradable coating thereon towards the rotor.

The present application further provides for a rotary machine. The rotary machine may include a stator housing, a rotor, a pair of elliptical sealing segments positioned therebetween with an abradable coating thereon, and a number of biasing members in communication with the pair of elliptical sealing segments and the stator housing so as to bias the pair of elliptical sealing segments with the abradable coating thereon towards the rotor.

These and other features and improvements of the present application will become apparent to one of ordinary skill in the art upon review of the following detailed description when taken in conjunction with the several drawings and the appended claims.

### BRIEF DESCRIPTION OF THE DRAWINGS

FIG. 1 is a schematic view of a gas turbine engine.

FIG. 2 is a cross-sectional view of an elliptical sealing system as may be described herein positioned within a rotary machine.

FIG. 3 is an axial view of the elliptical sealing system of FIG. 2 positioned about a rotor of the rotary machine.

### DETAILED DESCRIPTION

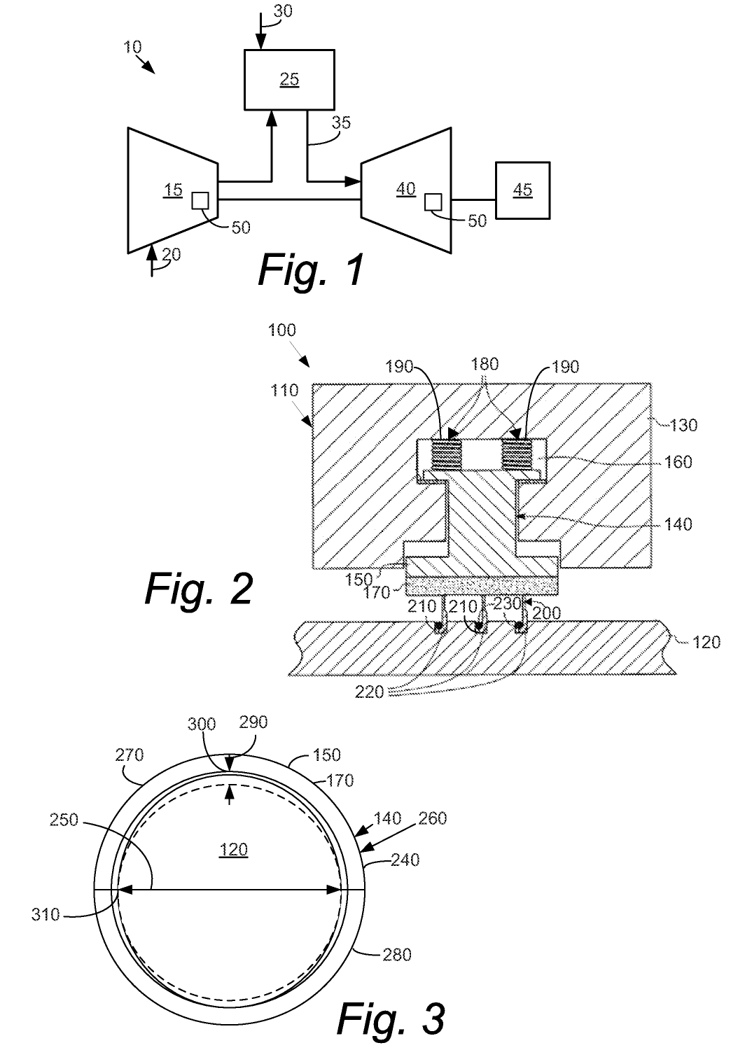

Referring now to the drawings, in which like numerals refer to like elements throughout the several views, FIG. 1 shows a schematic view of a rotary machine such as gas turbine engine 10. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a compressed flow of fuel 30 and ignites the mixture to create a flow of combustion gases 35. Although only a single combustor 25 is shown, the gas turbine engine 10 may include any number of combustors 25. The flow of combustion gases 35 is delivered in turn to a turbine 40. The flow of combustion gases 35 drives the turbine 40 so as to produce mechanical work. The mechanical work produced in the turbine 40 drives the compressor 15 and an external load 45 such as an electrical generator and the like.

The gas turbine engine 10 may use natural gas, various types of syngas, and/or other types of fuels. The gas turbine engine 10 may be one of any number of different gas turbine engines offered by General Electric Company of Schenectady, N.Y. and the like. The gas turbine engine 10 may have other configurations and may use other types of components. Other types of gas turbine engines also may be used herein. Multiple gas turbine engines 10, other types of turbines, and other types of power generation equipment also may be used herein together. Other types of rotary machines also may be used herein.

Gas leakage out of the gas path or into the gas path of the gas turbine engine 10 from an area of higher pressure to an area of lower pressure generally is undesirable. As described above, gas path leakage in the compressor 15 and/or in the turbine 40 may lower the efficiency of the overall gas turbine engine 10 and lead to increased fuel costs. The gas turbine engine 10 therefore may include a sealing system 50 provided in the compressor 15 and/or the turbine 40. The sealing system 50 facilitates a minimum clearance between the stationary components and the rotating components therein. As a result, fluid leakage through these components may be minimized so as to enhance overall efficiency.

FIG. 2 shows a portion of rotary machine 100 as may be described herein. In this example, the rotary machine 100 may include a compressor 110 similar to compressor 15 described above. Generally described, the compressor 110 includes a rotor 120 disposed inside a stator housing 130. The rotor 120 may be coupled to an input device shaft (not shown) or otherwise. Likewise, the stator housing 130 may include a number of suction ports and discharge ports (not shown) communicating fluid to and from the rotor 120 and the components thereof or otherwise. During rotation of the rotor 120, an incoming fluid may be sucked through the suction ports and a compressed fluid may be discharged through the discharge ports. Other configurations and other components may be used herein.

An elliptical sealing system 140 may be positioned between the rotor 120 and the stator housing 130. The elliptical sealing system 140 may be configured to control the leakage of the fluid therethrough without damaging the components thereof. Although described herein in the context of the compressor 110, the elliptical sealing system 140 may be used with any type of rotary machine 100, including steam turbines, gas turbines, and the like.

The elliptical sealing system 140 may include a retractable packing ring 150 positioned within a slot 160 of the stator housing 130. The packing ring 150 may be generally I-shaped although other configurations may be used herein. The packing ring 150 may include an abradable coating 170 facing the rotor 120. The abradable coating 170 may include an alloy of cobalt, nickel, chromium, aluminum, yttrium, hexagonal boron nitride, and polymers such as polyesters, polyimides, or the like. Alternatively, the abradable coating 170 may include nickel, chromium, aluminum, and clay (bentonite). Further, the abradable coating 170 may include nickel, graphite, and stainless steel. Further, the abradable coating 170 may include nickel, chromium, iron, aluminum, boron and nitrogen. Further, the abradable coating 170 may also include non-metallic materials (e.g., polytetrafluoroethylene applied by electrostatic powder coating process or polytetrafluoroethylene filled synthetic mica which may be attached by a mechanical device). The abradable coating 170 may use any desired material in any desired size, shape, and/or orientation.

A number of biasing members 180 such as springs 190 may be disposed between the packing ring 150 and the stator housing 130. The biasing members 180 may include leaf springs, coil springs, helical springs, hydraulic springs, pneumatic springs, stacked washers, and the like. The biasing members 180 may be configured to bias the packing ring 150 towards the rotor 120. In this example, the biasing members 180 may be positioned at about a 12 o'clock position and about a 6 o'clock position. Other positions may be used herein. Any number or type of biasing members 180 may be used herein. Other configurations and other components may be used herein.

The rotor 120 also may include a number of teeth 200 extending towards the elliptical sealing system 140. The teeth 200 may be in the form of a number of “J”-type strips 210 positioned within a number of slots 220 on the rotor 120. The J-strips 210 may be held in place within the rotor slots 220 via a number of wires 230 or other types of connection means. The J-strips 210 may be made of out stainless steel or other types of substantially rigid materials. Some or all of the J-strips 210 may be in contact with the abradable coating 170 of the rotor 120. The J-strips 210 may be detachable from the rotor 120 for replacement if damaged or worn via contact with the abradable coating 170. Other configurations and other components may be used herein.

FIG. 3 shows an axial view of the elliptical sealing system 140. As is shown, the elliptical sealing system 140 may have a largely elliptical shape 240. Specifically, the packing ring 150 with the abradable coating 170 may largely form the elliptical shape 240. By use of the term “elliptical”, we also include various types of hyperboloid, parabaloid, and other types of similar shapes. Other configurations may be used herein. The elliptical sealing system 140 is shown as positioned about the rotor 120. A horizontal arrow 250 shows the seal major axis that is substantially equal to the outside diameter of the rotor 120 and the extended teeth 200 or the J-strips 210. Other configurations may be used herein.

The elliptical sealing system 140 also may have a number of segments 260. In this example the elliptical sealing system 140 may have only two (2) segments 260, a first half 270 and a second half 280. Any number of segments 260 may be used herein. By only using the two (2) halves 270, 280, no additional end gap leakage may be introduced through the elliptical sealing system 140. Likewise, the use of the biasing members 180 at about the 12 o'clock position (shown at vertical arrows 290) and about at the 6 o'clock position generally forces the halves 270, 280 towards the center and the rotor 120 for contact therewith. Operating pressures also may provide additional sealing force.

The use of the elliptical shape 240 allows for an interference engagement 300 between the abradable coating 170 of the elliptical sealing system 140 and the J-strips 210 of the rotor 120. Specifically, the biasing members 180 allow for a deeper interference engagement 300 at about the 6 o'clock position and about the 12 o'clock position while providing for a line on line engagement 310 at about the 3 o'clock and about the 9 o'clock position. The sealing system 140 thus acts as a wheel eye seal with improved radial engagement. Likewise, no additional end gap leakage may be introduced through the elliptical sealing system 140 given the use of a minimum number of segments 260, the first half 270 and the second half 280. Such reduced leakage flows therethrough should increase overall compressor and rotary machine efficiency through the combination herein of the elliptical shape 240, the biasing members 180, and/or the abradable coating 170.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. An elliptical sealing system for use with a rotor and a stator housing of a rotary machine, comprising:
a plurality of seating segments;
each of the plurality of sealing segments comprising an abradable coating thereon;
the plurality of sealing segments with the abradable coating thereon comprising a substantially elliptical shape; and
a plurality of biasing members in communication with the plurality of sealing segments and the stator housing.

2. The elliptical sealing system of claim 1, wherein the plurality of sealing segments comprises a packing ring.

3. The elliptical sealing system of claim 1, wherein the plurality of sealing segments comprises a first half and a second half.

4. The elliptical sealing system of claim 1, wherein the rotor comprises a plurality of teeth thereon and wherein the plurality of teeth engage the abradable coating of the plurality of sealing segments.

5. The elliptical sealing system of claim 4, wherein the plurality of teeth comprising a plurality of J-strips and wherein the plurality of J-strips engage the abradable coating of the plurality of sealing segments.

6. The elliptical sealing system of claim 1, wherein the plurality of biasing members are positioned at about a 12 o'clock position and about a 6 o'clock position to bias the plurality of sealing segments towards the rotor.

7. The elliptical sealing system of claim 1, wherein the plurality of biasing members comprises a plurality of springs to bias the plurality of sealing segments towards the rotor.

8. The elliptical sealing system of claim 1, wherein the plurality of sealing segments with the abradable coating thereon comprises an interference engagement with the rotor at about a 12 o'clock position and about a 6 o'clock position.

9. The elliptical sealing system of claim 1, wherein the plurality of sealing segments with the abradable coating thereon comprises a line on line engagement with the rotor at about a 3 o'clock position and about a 9 o'clock position.

10. The elliptical sealing system of claim 1, wherein the plurality of sealing segments with the abradable coating thereon comprises a seal major axis of about an outer diameter of the rotor and a plurality of teeth thereon.

11. The elliptical sealing system of claim 1, wherein the rotary machine comprises a compressor.

12. An elliptical sealing system for use with a rotor and a stator housing of a rotary machine, comprising:
a pair of elliptical sealing segments;
the pair of elliptical sealing segments comprising an abradable coating thereon; and
a plurality of biasing members in communication with the pair of elliptical sealing segments and the stator housing so as to bias the pair of elliptical sealing segments with the abradable coating thereon towards the rotor.

13. The elliptical sealing system of claim 12, wherein the pair of elliptical sealing segments comprises a packing ring.

14. The elliptical sealing system of claim 12, wherein the rotor comprises a plurality of teeth thereon and wherein the plurality of teeth engage the abradable coating of the pair of elliptical sealing segments.

15. The elliptical sealing system of claim 14, wherein the plurality of teeth comprising a plurality of J-strips and wherein the plurality of J-strips engage the abradable coating of the pair of elliptical sealing segments.

16. The elliptical sealing system of claim 12, wherein the plurality of biasing members are positioned at about a 12 o'clock position and about a 6 o'clock position to bias the pair of elliptical sealing segments towards the rotor.

17. The elliptical sealing system of claim 12, wherein the plurality of biasing members comprises a plurality of springs to bias the pair of elliptical sealing segments towards the rotor.

18. The elliptical sealing system of claim 12, wherein the pair of elliptical sealing segments with the abradable coating thereon comprises an interference engagement with the rotor at about a 12 o'clock position and about a 6 o'clock position.

19. The elliptical sealing system of claim 12, wherein the pair of elliptical sealing segments with the abradable coating thereon comprises a line on line engagement with the rotor at about a 3 o'clock position and about a 9 o'clock position.

20. A rotary machine, comprising:
a stator housing;
a rotor;
a pair of elliptical sealing segments positioned therebetween;
the pair of elliptical sealing segments comprising an abradable coating thereon; and
a plurality of biasing members in communication with the pair of elliptical sealing segments and the stator housing so as to bias the pair of elliptical sealing segments with the abradable coating thereon towards the rotor.
